(19) United States
(12) Patent Application Publication
(10) Pub. No.: US 2006/0173618 A1
(43) Pub. Date: Aug. 3, 2006

(54) Intelligent travel assistant

(76) Inventors: Mark Eyer, Woodinville, WA (US); Donald Moore, Renton, WA (US); Micheale McKay, Shoreline, WA (US); Mark Champion, Kenmore, WA (US); Christopher MacGregor, Seattle, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/048,549

(22) Filed: Feb. 1, 2005

(51) Int. Cl. G01C 21/36

(52) U.S. Cl. 701/213; 701/200

(57) ABSTRACT

In one embodiment, a method comprises monitoring geographical locations of a device equipped with a global positioning satellite (GPS) receiver, which is moved over a travel route. During movement or subsequently thereafter, information pertaining to the geographical locations is uploaded to a processing center to compute travel patterns for the commuter in possession of the device. As a result, prior to the normal point of time when the computer travels over the travel route, travel-related information for the travel route is downloaded to the device for use in selecting a route of travel.

### FIELD

Embodiments of the invention relate to the field of global positioning system (GPS). More specifically, various embodiments of the invention relate to a portable GPS-equipped device and method for providing travel-related information associated with travel patterns for users of the GPS-equipped device.

### GENERAL BACKGROUND

Many cities are plagued by excessive traffic congestion. As a result, many drivers normally consult some sort of travel advisory in order to avoid congested traffic routes and minimize driving time. Currently, there are many types of travel advisories, such as roadside signs, broadcast traffic reports from local radio and television stations, and Internet-based traffic reports. None of these travel advisories, however, are particularly useful to drivers on a daily basis.

For instance, local radio stations broadcast traffic alerts in order to inform drivers of supposedly congested travel routes. This allows drivers to select alternate travel routes to their respective destinations. However, each broadcast traffic alert only reports on a small percentage of congested travel routes. Hence, presuming that these traffic alerts are accurate, which are sometimes not the case when based on inaccurate information, they tend to offer no meaningful guidance when the driver's intended travel route is not broadcast.

Various Internet sites offer real-time traffic maps. However, the use of Internet sites for travel planning of repetitive trips, such as driving to work each day, is inconvenient and time consuming. Typically, access to real-time traffic data involves the driver booting his or her computer, connecting to the Internet (possibly via telephone dial-up) and accessing a traffic reporting website. His or her computer may not be conveniently accessible within the household; it is possible the driver may not own a computer or have Internet access. Even when a computer and Internet access is available, the process may take anywhere up to five minutes or more, which effectively adds even more time to the overall commuting time for the driver.

### BRIEF DESCRIPTION OF THE DRAWINGS

The features and advantages of the invention will become apparent from the following detailed description of the invention in which:

FIG. 1 is an exemplary embodiment of a wireless system with a portable global positioning system (GPS) device that is adapted as a GPS receiver supplying GPS information to a processing center and receiving traffic reports for travel patterns associated with the GPS information.

FIG. 2 is an exemplary embodiment of the external elements forming the GPS device of FIG. 1.

FIGS. 3A-3C illustrate exemplary screen types shown on the display of the GPS device of FIG. 2 to enable the commuter to determine an optimal travel route.

FIG. 4 is an exemplary embodiment of internal logic of the GPS device of FIG. 1.

FIG. 5 is an exemplary embodiment of the interoperability between GPS enhancement software and the Operating System of the GPS device of FIG. 4.

FIG. 6 is a first exemplary flowchart describing the general operations associated with continuous uploading of GPS information to a processing center.

FIG. 7 is a second exemplary flowchart describing the general operations associated with user-controlled uploading of GPS information to a processing center.

FIG. 8 is a first exemplary flowchart of the operations associated with the download of travel-related information for a travel route to the portable GPS device of FIGS. 2 and 4.

FIG. 9 is a second exemplary flowchart of the operations associated with the download of travel-related information for a travel route to the portable GPS device of FIGS. 2 and 4.

FIG. 10 is a third exemplary flowchart of the operations associated with the download of travel-related information for a travel route to the portable GPS device of FIGS. 2 and 4.

FIGS. 11A-11C are exemplary schematic diagrams of a traffic map illustrating GPS sample times for two different travel routes and screen image featuring one or more of the travel routes downloaded next morning.

### DETAILED DESCRIPTION

Embodiments of the invention relate to the field of global positioning system (GPS). More specifically, various embodiments of the invention relate to a portable GPS-equipped device and method for monitoring travel patterns of users possessing the GPS-equipped device and timely downloading travel-related information associated with one or more travel routes for various travel patterns.

In general, embodiments of the invention take advantage of two-way communications paths available to mobile devices combined with GPS location technology. Using concepts described in this disclosure, a portable GPS device, such as an enhanced cell phone for example, communicates GPS location information from the commuter's vehicle to a processing center, and that same device receives custom-tailored travel-related information and drive-time alerts.

Herein, certain terminology is used to discuss features of the invention. For example, the term “commuter” generally refers to the user of a portable global positioning system (GPS) device who intends to travel to a specific destination along a chosen route. “GPS information” includes static values identifying a geographic location of the GPS device at a specific sampling time. These static values are computed from global positioning signals from satellites. “Travel-related information” includes any information that can be used to better determine a path of travel. Examples of travel-related information include, but are not limited or restricted to one or more of the following: estimated travel time; average travel speed; notification of congested areas due to road closures, lane closures or accidents; suggestions for alternate routes; and/or weather related data such as storm conditions, possibility for ice on the roadway, or the like.

In addition, a “portable GPS device” is generally defined as any device equipped with GPS receiver technology and adapted to conduct GPS computations, namely the collection and processing of global positioning signals at particular sample times. One embodiment of a portable GPS device includes a wireless (cellular) telephone with GPS functionality, although other types of products may apply such as a personal digital assistant (PDA), a hand-held GPS receiver or even a hand-held computer for example.

With respect to particular components of the portable GPS device, a “processor” is generally defined as a component that processes information such as a microprocessor, a digital signal processor, an application specific integrated circuit (ASIC), a micro-controller and the like. “Software” is generally defined as one or more instructions that when executed, cause the GPS device to perform a certain function or operation. The instructions are stored in machine-readable medium, which is any medium that can store and transfer information. Examples of machine-readable medium include, but are not limited to an electronic circuit, a semiconductor memory device (volatile or non-volatile), a data storage disk (e.g. mechanical or optical disk drive) or even any portable storage media such as a diskette, a disc, a tape, a card, a USB flash drive, or the like.

I. SYSTEM ARCHITECTURE

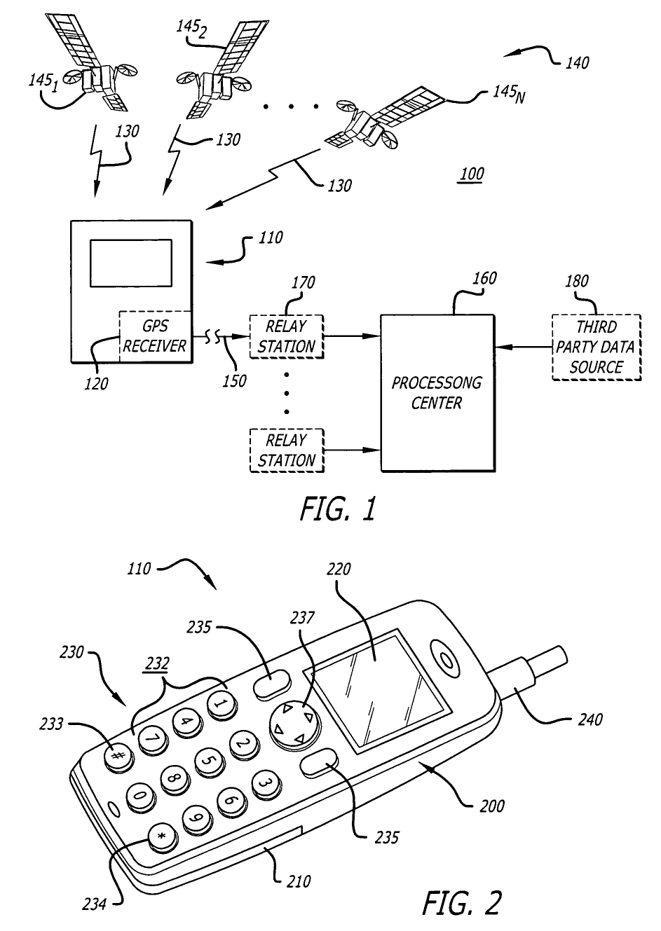

Referring to FIG. 1, an exemplary embodiment of a wireless system 100 is shown. Wireless system 100 comprises a portable GPS device 110, which includes a GPS receiver 120 adapted to receive global positioning signals 130 from satellites forming a Global Positioning System (GPS) 140.

More specifically, GPS 140 is a constellation of satellites orbiting the Earth. These satellites are positioned so that three or more satellites 145₁-145_{N} (N≧3) are in the field of view of GPS device 110 when located at virtually any place on Earth. Each satellite 145₁, . . . , or 145_{N} transmits time-based global positioning signals 130. The precise location of GPS device 110 can be determined through trilateration, namely measurements of the time required for global positioning signals 130 from satellites 145₁-145_{N} to reach GPS device 110. From global positioning signals 130, GPS receiver 120 is able to compute its location and convert the same into GPS information 150, which identifies its geographical position (e.g., latitude and longitude).

GPS information 150 is uploaded to a processing center 160. The uploading of GPS information 150 may be conducted according to a variety of techniques. One technique involves an upload after a certain number of sampling events have been conducted by GPS device 110. For instance, the upload may occur either after every sampling event, namely after every computation by GPS device 110 of its location, or after multiple sampling events have been conducted. For the later upload procedure, the resultant GPS information may be temporarily stored within GPS device 110. Yet another technique involves an upload after a certain period of time has elapsed. Alternatively or in combination with the above-mentioned upload procedures, an upload would need to be conducted at the end of a GPS monitored travel route as described below.

It is contemplated that processing center 160 may receive GPS information from one or more optional relay stations 170, which are positioned throughout a particular coverage area and in communication with processing center 160 and represented by dashed lines. Relay stations 170 receive GPS information from all GPS devices throughout the coverage area and provide this information to processing center 160 for traffic analysis. Likewise, processing center 160 may be in communication with one or more optional third party data sources 180 to acquire information about traffic, weather or other travel-related conditions from other sources. Examples of these third party data sources 180 include, but are not limited or restricted to various commercial or governmental entities having knowledge to traffic conditions (e.g., databases maintained by local or state transportation bureaus, law enforcement, etc.), Internet web sites or the like.

According to one embodiment, as processing center 160 receives GPS information from GPS device 110, it determines travel patterns by GPS device 110 based on historical sampling at general locations. These travel patterns include specific travel routes and normal times of travel. According to another embodiment, in lieu of a travel pattern being determined by processing center 160, it is contemplated that the commuter may be responsible for identifying his or her travel pattern, which would be stored by processing center 160.

Thereafter, either automatically or prompted by GPS device 110, processing center 160 is adapted to provide travel-related information concerning one or more travel routes to GPS device 110. Processing center 160 receives GPS information from multiple GPS devices and transmits travel-related information to those GPS devices. The travel-related information is transmitted in real-time, and is constantly updated to reflect the most current travel conditions. Although not shown, processing center 160 includes a central communication device, a server, and a mass storage device. These components enables processing center 160 to communicate with any one of the GPS devices by a wireless communication path, process the incoming GPS information and to store an archive of information such as code, programs, files, data, applications, GPS and travel-related information, and information (data and/or address and/or control) for establishing communications with the GPS devices.

As an optional feature, processing center 160 could send unprompted emergency notifications to the GPS device 110 in response to unexpected events adversely affecting a path of travel such as accidents or unplanned road closures for example. Updated travel-related information may be sent whenever a change of any significance occurs.

II. GPS DEVICE ARCHITECTURE

A. Exemplary GPS Device Architecture (External)

Referring now to FIG. 2, a first exemplary embodiment of exterior elements of GPS device 110 is shown. GPS device 110 comprises a housing 200 made of a rigid or semi-rigid material such as hardened plastic. Housing 200 is adapted to receive a battery 210, which supplies power to internal components within housing 200, some of which are described below.

According to this embodiment of the invention, GPS device 110 further comprises a display 220, a keypad 230 and an antenna 240 adapted to receive wireless signals. For instance, antenna 240 may include a single antenna tuned to receive and transmit signals at satellite and cellular frequencies or a plurality of antennas (internal and/or external), such as a first antenna adapted to receive satellite signals, one form of wireless signal, as well as a second antenna adapted to receive and transmit signals at a cellular frequency.

As shown, display 220 provides a visual interface for a commuter to view traffic conditions along one or more travel routes. For one embodiment, such configuration may be accomplished by depressing various buttons associated with keypad 230. Keypad 230 includes a standard set of single digit number buttons (0-9) 232 as well as various symbol buttons “#” and “*” buttons 233 and 234. Other keypad buttons include a DISCONNECT button 235, a CONNECT button 236 and a MENU NAVIGATION button 237. Of course, where display 220 is a touch screen, certain tasks may be handled using display 220, thereby eliminating the need for keypad 230.

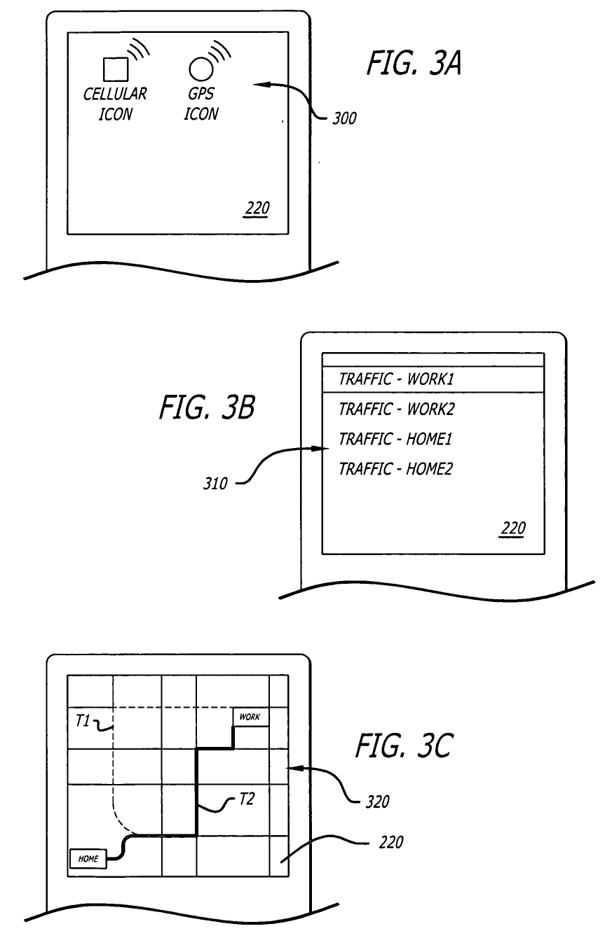

According to one embodiment of the invention, travel-related information is downloaded into GPS device 110. The download may be initiated by GPS device 110 or may be automatically transmitted prior to the commuter proceeding to a desired destination. The travel-related information may be accessed by the commuter depressing MENU NAVIGATION button 237, progressing to a main menu screen, and then selecting a GPS icon 300. As shown in FIGS. 3A and 3B, after selecting GPS icon 300, an index 310 may be provided to allow the commuter to selectively view traffic conditions for a particular travel route.

Alternatively, in lieu of index 310, after selecting GPS icon 300, a digitized map 320 may be shown on display 220 with traffic conditions (e.g., time of travel, average speed, etc.) displayed over portions of one or more normal travel routes. It is contemplated that statistics from the travel-related information may be illustrated or hidden (as shown) until a corresponding number on the keypad is depressed.

Moreover, as further shown in FIG. 3C, travel routes with unexpected or abnormal delays 330 (e.g., route T1) may be appropriately identified, such as in a particular color or degree of illumination, while optimal travel routes (T2) 340 may be appropriately identified as well.

B. Exemplary GPS Device Architecture (Internal)

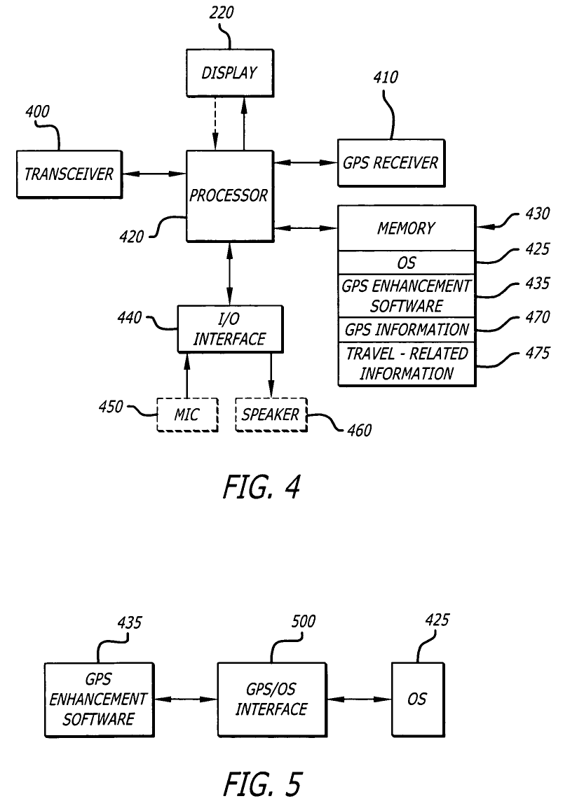

Referring to FIG. 4, an exemplary embodiment of internal logic of GPS device 110 is shown. GPS device 110 comprises display 220, a transceiver 400, a GPS receiver 410, a processor 420, an internal memory 430 and an input/output (I/O) interface 440 to enable information to be provided to processor 420 from peripherals such as keypad 230 of FIG. 2. As an option, GPS device 110 may further include a microphone 450 and speaker 460 if GPS device 110 further operates as a cellular telephone.

Coupled to antenna 240 of FIG. 2 and processor 420, transceiver 400 comprises hardware, firmware, software or any combination thereof for processing incoming or outgoing audio messages. For example, according to one embodiment of the invention, although not shown, transceiver 400 comprises a demodulator and/or modulator as well as a digital-to-analog converter (DAC) and/or an analog-to-digital converter (ADC). Transceiver 400 is configured to transmit audio messages based on audio captured by microphone 450. Likewise, transceiver 400 is configured to receive incoming audio messages and to extract the audio for playback over speakers 460. In the event that alphanumeric text is received in lieu of audio messages, the implementation of the DAC or ADC within transceiver 400 may not be necessary.

Coupled to processor 420, GPS receiver 410 is adapted to receive global positioning signals received from multiple satellites. Under control by Operating System (OS) 425, which may be stored in internal memory of processor 420 (not shown) or in local memory 430, processor 420 executes GPS enhancement software 435. Stored in local memory 430, upon execution by processor 420, GPS enhancement software 435 is configured to perform 2D or 3D trilateration in order to compute GPS information 470 based on these global positioning signals. As shown, GPS information 470 as well as travel-related information 475 may be stored in local memory 430.

GPS enhancement software 435 may be downloaded into a targeted GPS device 110 for a one-time or periodic service fee. However, as shown in FIG. 5, GPS device 110 is adapted with a GPS/OS interface 500 to enable OS 425 to communicate with GPS enhancement software 435 if this software is downloaded and utilized.

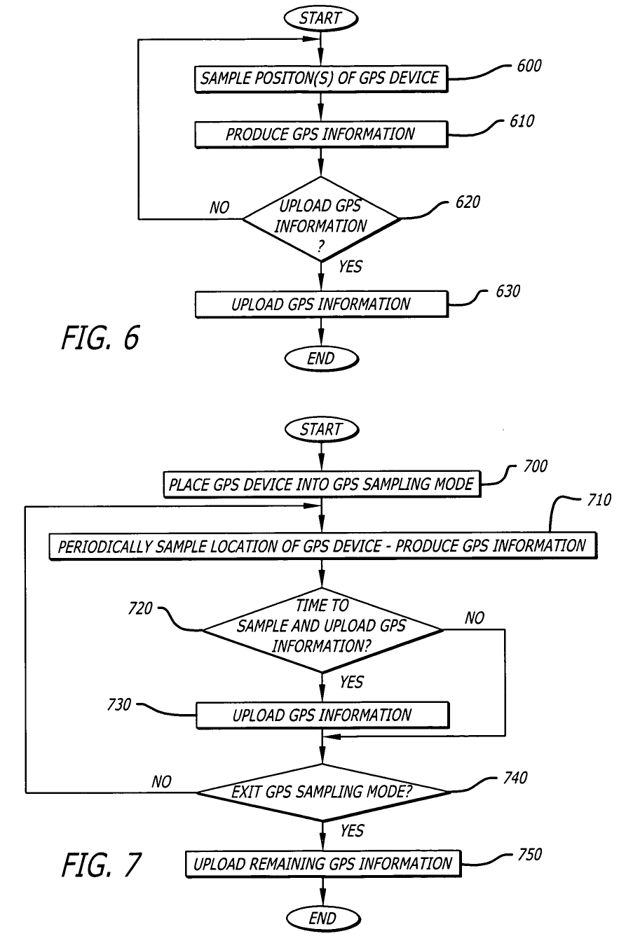

Referring now to FIG. 6, a first exemplary flowchart describing the general operations associated with continuous uploading of GPS information to processing center 160 of FIG. 1 is shown. Initially, a position of the GPS device is sampled by controlling the antenna to receive global positioning signals from viewable satellites (block 600). Such sampling may be conducted repeatedly at prescribed time intervals or time-varying intervals. Data from the global positioning signals is processed to produce GPS information (block 610), which may be locally stored.

Where upload responsibility resides with the GPS device, a determination is made whether the GPS information should be uploaded (block 620). According to one embodiment of the invention, this determination may be time-based or based on the number of samples after the last upload. Upon such determination, the GPS information is uploaded to the processing center (block 630). Otherwise, the GPS information is accumulated and stored within the GPS device for later uploading.

According to other embodiments, which are not illustrated, the GPS information may be automatically updated at selected time intervals or in response to a polling operation. In addition, the uploading of the GPS information may be in response to a signal by processing center 160 requesting whether or not the GPS device transmits travel-related information to processing center 160 or another device for forwarding to processing center 160. For instance, the uploading of the GPS information may be prompted in response to detection of a predetermined event such as abnormally slow speed compared with expected speeds (or posted speed limits) over a path of travel. Detection may be made by processing center 160 or GPS device 110 of FIG. 1.

Referring to FIG. 7, a second exemplary flowchart describing the general operations associated with user-controlled uploading of GPS information to a processing center is shown. Initially, the commuter places the GPS device into a GPS sampling mode (block 700). In this mode, the GPS device receives global positioning signals, processes such signals to produce GPS information and uploads the GPS information to the processing center. This provides the commuter with the ability to designate certain movement as a particular travel route (for potential later receipt of travel-related information), without requiring the processing center to compute travel routes for the commuter.

At prescribed sampling times, the GPS device samples its location by producing GPS information associated with that location (block 710). Optionally, the GPS information can be sampled and uploaded prior to exiting from the GPS sampling mode (blocks 720 and 730). Regardless of whether or not uploading is conducted at times when the GPS sampling mode is active, upon existing from the GPS sampling mode, the GPS device uploads the computed GPS information for the last location and any other stored GPS information (blocks 740 and 750. Of course, it is contemplated that the computed GPS information may be compressed before uploading is conducted.

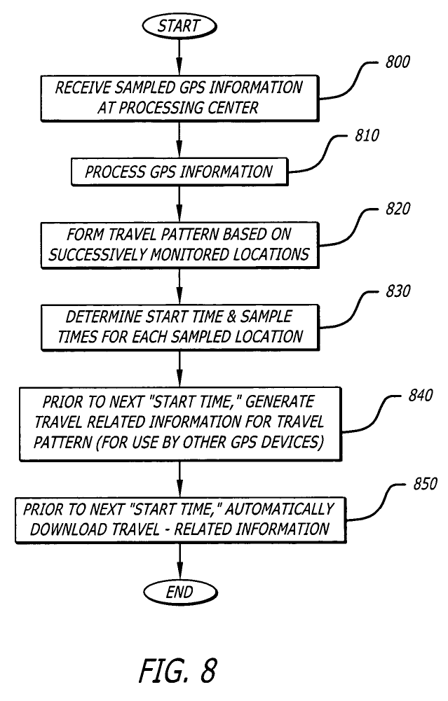

Referring now to FIG. 8, a first exemplary flowchart of the operations associated with the download of travel-related information for a travel route to the portable GPS device of FIGS. 2 and 4 is shown. At the processing center, sampled GPS information is received from the GPS device (block 800). The GPS information is processed, from which data concerning successive geographic locations of the GPS device may be obtained (block 810).

Collectively, these geographic locations constitute a travel pattern, which is detected based on a continued collection of the same GPS information according to one embodiment of the invention. Of course, in accordance with another embodiment of the invention, the successive geographic locations sampled in response to activity by the commuter may constitute a travel pattern. More specifically, the commuter may proactively activate certain recording and reporting functionality of the GPS device to monitor and log the location only when the commuter wants to establish a travel route to be monitored by the processing center.

Besides the geographic locations forming these travel routes, it is contemplated that start time for these travel routes may be computed and appropriately stored (block 830). According to one embodiment, a “scheduled” start time may be computed by taking an average time as to when the commuter proceeds on a certain travel route, taking into account variations by day of the week (and accounting for holidays). According to another embodiment, an “actual” start time may be computed by detecting movement of the GPS device from a geographic location where samples over a prolonged period of time have occurred (e.g., over four hours of sampling at a location). Of course, this “actual” start time may be used to derive the “typical” start time.

Besides being used to establish a travel route and its start time, the GPS information can be used as data for generating travel-related information for other GPS devices (block 840), where processing center 160 uses travel-related information gathered from other GPS device that have traveled the same (anticipated) route some short time earlier. This provides the commuter with a “look-ahead” for slowdowns upcoming on his route, to allow him to avoid traffic bottlenecks. Additional discussion of this feature is set forth in a co-pending U.S. Patent Application entitled “Distributed GPS Traffic Information System” (Atty. Docket No. 080398.P618), owned by the assignee of the subject application and whose the contents are incorporated by reference.

For instance, the travel speed experienced by the GPS device may be computed since the distance traveled between successive sampling points and the time elapsed between these such sampling would be known. Similarly, the GPS information supplied by other GPS devices and information from third party sources may be used to provide travel-related information for use by the commuter.

Prior to the normal start time for a stored travel route, identified as a travel pattern for the commuter, the processing center automatically downloads travel-related information associated with the travel route and perhaps other alternative travel routes (block 850). This allows the commuter to review traffic, road, and weather conditions before proceeding along a specified travel route, and enables pre-notification of delays to allow the traveler to get an early start on the trip.

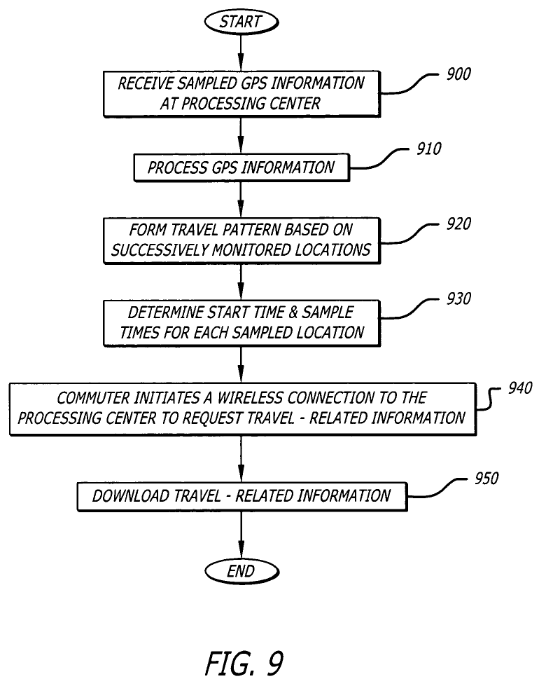

Referring to FIG. 9, a second exemplary flowchart of the operations associated with the download of travel-related information for a travel route to the portable GPS device of FIGS. 2 and 4 is shown. Initially, travel routes and GPS information are obtained in the same manner as shown in blocks 810-830 of FIG. 8 (blocks 900-930). However, in lieu of automatic download of data from the processing center, the commuter initiates a wireless connection to the processing center to request travel-related information (block 940). This information may be specific to a particular travel route or specific to a general time frame in which the processing center has detected one or more travel routes for the requesting commuter.

Based on the request from the GPS device, the processing center downloads the travel-related information to the GPS device (block 950). The travel-related information may be illustrated as a digitized map shown in FIG. 3C with streets and highways shown and travel routes identified. Alternately, the travel-related information may be illustrated as alphanumeric text, identifying estimated travel time, estimated time of arrival, average travel speed, and the like. Both types of information will provide the commuter with sufficient data to determine his or her appropriate travel route.

During the travel route, where the processing center anticipated the commuter is coming upon an unanticipated slowdown (e.g., accident, road closure, “sig” alert, etc.), a notification is sent from the processing center to the GPS device. The notification may simply be audio, text message, or GPS information providing alternative travel routes to the commuter.

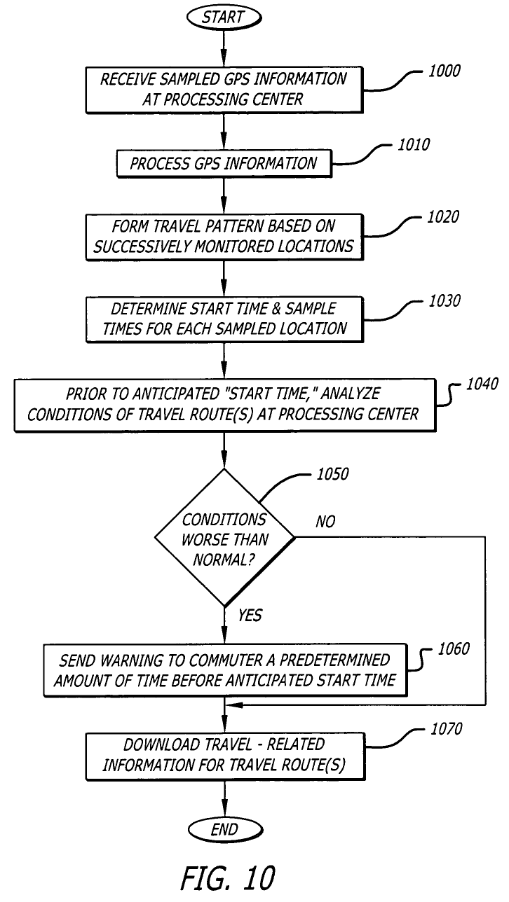

Referring to FIG. 10, a third exemplary flowchart of the operations associated with the download of travel-related information for a travel route to the portable GPS device of FIGS. 2 and 4 is shown. Initially, travel routes and GPS information are obtained as described in FIGS. 8 and 9 (blocks 1000-1030). One difference is that, at a predetermined time before the commuter normally undergoes a specified travel route, the conditions of the travel route are analyzed by the processing center (block 1040). The predetermined time may be anywhere from a few minutes to an hour or so before the normal start time.

Upon determining that the traffic conditions are worse than normal for the particular travel route, an early warning is provided to the commuter in possession of the GPS device to indicate problematic traffic conditions (blocks 1050 and 1060). This warning may be accomplished by the processing center initiating a telephone call or generating a wireless signal that, upon detection by the GPS device, causes a ringer to activate or causes a certain image to be produced on the display. The warning may precede or follow the downloading of the travel-related information (block 1070).

In the event that the traffic conditions are normal or better than normal, the travel-related information is sent at its normal time and no warnings are issued (block 1070).

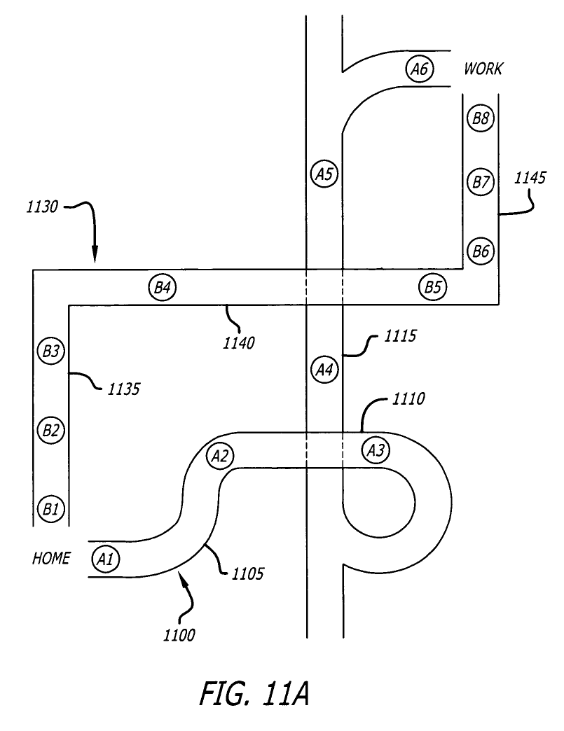

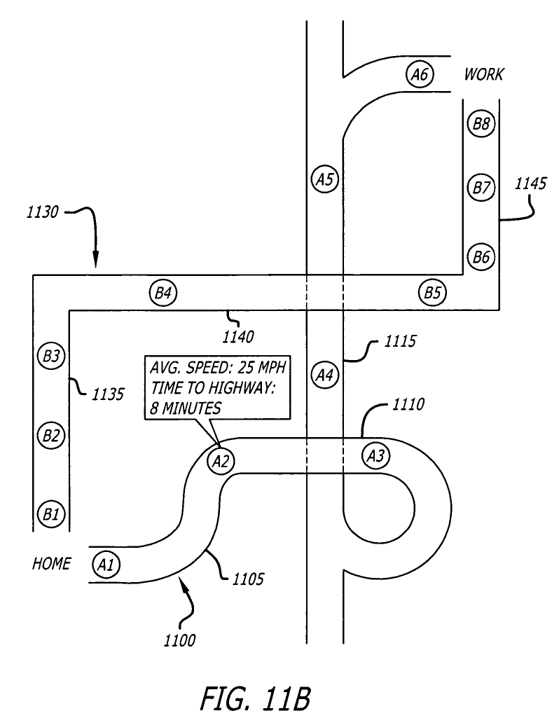

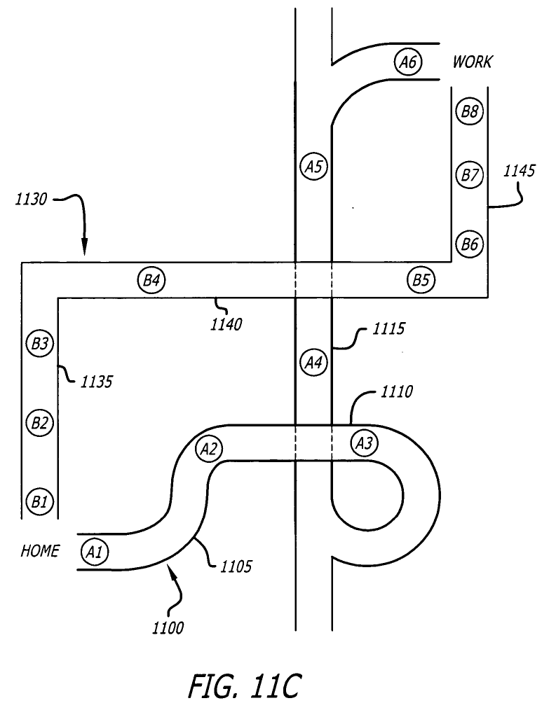

Referring to FIGS. 11A-11C, exemplary schematic diagrams of a digitized map illustrating sampling points along two different travel routes 1100 and 1130 previously undertaken by the commuter and a screen image featuring these travel routes for one morning is shown.

As shown in FIG. 11A, a commuter has previously driven two travel routes from home to his place of business. First travel route 1100 involves the commuter using two residential streets 1105 and 1110 in order to reach a highway 1115, and traveling a substantial portion of his compute along highway 1115. The normal travel time is approximately twenty-five minutes between 8:00 A.M. and 8:25 A.M. At a sample rate of one sample per 5 minutes, at least six (6) GPS samples occurred before the commuter arrived at his place of business. The sample points are illustrated as A1-A6. Note that in a more realistic implementation, samples would likely be taken at a substantially faster rate.

Second travel route 1130 involves the complete use of residential streets 1135, 1140 and 1145, excluding highway 1115. The normal travel time is approximately thirty-five minutes between 8:00 A.M. and 8:35 A.M. At a sample rate of one sample per 5 minutes, at least eight (8) GPS samples occurred before the commuter arrived at his place of business. These sample points are illustrated as B1-B8.

Prior to 8:00 A.M., travel-related information associated with the first and/or second travel routes 1100 and 1130 is transmitted to the GPS device. As shown in FIG. 11A, both travel routes 1100 and 1130 appear to have no abnormal traffic conditions and provide options to the commuter as to which travel route he or she would desire to take.

Each travel route 1100 and 1130 may be further analyzed in response to an event performed on the GPS device. For example, as shown in FIG. 11B, depression of a key (2) or use of a stylus and contact with sample point A2 on the display screen of the GPS device may cause the GPS device to present additional information concerning the specific travel route, such as for example, travel speed at sample point A2, estimated time of travel from A2 to highway 115 or the like.

In the event that one of the travel routes has abnormal traffic conditions, the route may be represented appropriately as shown in FIG. 11C. For example, first route 1100 with poor traffic conditions may be illuminated differently than second travel route 1130, such as with a more/less pronounced travel line, different color to identify the traffic level or the like. Additionally, as described above, each travel route 1100 and 1130 may be further analyzed in response to an event performed on the GPS device.

Those skilled in the art will recognize that the GPS device and method of the invention have many applications, and that the invention is not limited to the representative examples disclosed herein.

What is claimed is:

1. A method comprising:
deriving geographical locations of a device equipped with a global positioning satellite (GPS) receiver;
processing GPS location information comprising a plurality of sampled geographical locations; and
uploading the GPS information for use in determining one or more travel routes for a commuter in possession of the device and for subsequently downloading travel-related information associated with the one or more travel routes.

2. The method of claim 1, wherein the deriving of the geographical locations includes analysis of global positioning signals to determine a location of the device at a first point of time and analysis of the global positioning signals to determine a location of the device at a second point of time.

3. The method of claim 1, wherein the processing of the GPS information includes storing a value identifying the first point of time along with the information to identify the geographical location at the first point of time.

4. The method of claim 1 further comprising
computing a travel route associated with the plurality of sampled geographical locations;
determining a start time of the travel route; and
automatically downloading travel-related information for the travel route to the device prior to the start time.

5. The method of claim 4, wherein prior to automatically downloading the travel-related information, the method further comprising:
determining traffic conditions for the travel route at a predetermined time before downloading the travel-related information to the device;
notifying a commuter in possession of the device if the traffic conditions are worse than normal; and
downloading the travel-related information prior to a typical time for downloading the travel-related information.

6. The method of claim 1, wherein prior to sampling geographical locations, the method further comprising:
placing the device into a sampling mode.

7. The method of claim 6 further comprising:
determining a start time of at least one of the one or more travel routes; and
downloading travel-related information for the at least one of the one or more travel routes to the device prior to the start time.

8. The method of claim 7, wherein the downloading of travel-related information for the at least one of the one or more travel routes is automatic without activity by a commuter using the device.

9. The method of claim 4, wherein prior to downloading the travel-related information, the method further comprising:
determining traffic conditions for the at least one of the one or more travel routes a predetermine time before downloading of the travel-related information; and
notifying a commuter in possession of the device if the traffic conditions are worse than normal.

10. A method comprising:
monitoring geographical locations of a device equipped with a global positioning satellite (GPS) receiver being moved over a travel route starting at a first point of time when the device is at a first geographical location;
uploading information pertaining to the geographical locations to a processing center; and
downloading travel-related information for the travel route at a download time being prior to the first point of time.

11. The method of claim 10, wherein the monitoring of the geographical locations comprising:
placing the device into a sampling mode of operation;
sampling a first geographical location of the device upon placing the device into the sampling mode;
sampling successive geographical locations of the device at predetermined time intervals; and
sampling a final geographical location of the device upon exiting from the sampling mode of operation.

12. The method of claim 11, wherein the uploading of the information includes uploading one or more geographical location and corresponding sampling times.

13. The method of claim 10, wherein prior to downloading the travel-related information for the travel route, the method further comprising:
computing traffic conditions for the travel route by the processing center based on uploaded geographical location and sampling times from other devices with GPS receivers.

14. The method of claim 10 further comprising:
transmitting a warning prior to the download time if traffic conditions for the travel route are determined to be worse than normal.

15. The method of claim 10 further comprising:
downloading travel-related information for at least one travel route acting as an alternative to the travel route at the download time.

16. Embodied within a machine-readable medium executed by a processor within a device equipped with a global positioning satellite (GPS) receiver, a software comprising:
a first module to upload geographical locations of the device being moved over a travel route starting at a first point of time during a selected day when the device is at a first geographical location; and
a second module to download travel-related information for the travel route at a download time during a subsequent day after the selected day.

17. The software of claim 16, wherein the machine-readable medium being contained within a cellular telephone including the GPS receiver.

18. The software of claim 16, wherein the second module to download the travel-related information for the travel route prior to the first point of time during the subsequent day.

19. A processing center comprising:
means for communicating with one or more global satellite positioning (GPS) devices;
means for computing travel-related information associated with a historical travel route of a first GPS device of the one or more GPS devices; and
means for downloading the travel-related information.

20. The processing center of claim 19, wherein the means for downloading provides the travel-related information prior to a start time denoted by movement of the first GPS device after a prolonged time of non-movement.
